(19) United States
(12) Patent Application Publication
(10) Pub. No.: US 2008/0172498 A1
(43) Pub. Date: Jul. 17, 2008

(54) System and Apparatus for Managing Interactive Content, Advertising, and Devices

(76) Inventor: John Christian Boucard, Pasadena, CA (US)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/839,477

(22) Filed: Aug. 15, 2007

Related U.S. Application Data
(63) Continuation-in-part of application No. 11/836,072, filed on Aug. 8, 2007.
(60) Provisional application No. 60/884,845, filed on Jan. 12, 2007.

(51) Int. Cl. G06F 13/38; G06F 13/10; H04L 17/02

(52) U.S. Cl. 710/16; 380/52; 710/1; 710/8

(57) ABSTRACT

A memory device and system for managing links to content or digital assets in an on-line, network or software application environment. The links and digital assets may be represented by unique identifiers and pointers or similar data. The memory device can take the form of a piece of jewelry, handheld game device, memory stick, toy or similar item. The memory device can include communication ports to provide connectivity to multiple devices including other memory devices, computers and similar electronic devices. The memory device can also include an input mechanism that allows a user to select an output of the memory device. The memory device can include a sensor or similar component that detects and receives non-digital input. The non-digital input can come from any source including sources embedded within pieces of jewelry, toys, electronic devices or similar items. The non-digital input can be received and stored as a digital value or used to modify an existing digital value. The memory device and system enable processes for transferring data between the memory device and other electronic devices, receiving non-digital input and handling input to select an output of the memory device.

### CROSS-REFERENCE TO RELATED APPLICATIONS

This patent application claims the benefit of the filing date of U.S. Provisional Patent Application Ser. No. 60/884,845, filed on Jan. 12, 2007 and entitled “SYSTEM AND METHOD FOR ACCESSING PERSONAL ON-LINE INFORMATION WITH ADVERTISEMENT,” the entire content of which is hereby expressly incorporated by reference. The patent application is a continuation-in-part of and claims the benefit of the filing date of U.S. patent application Ser. No. 11/836,072 entitled “SYSTEM AND METHOD FOR ACCESSING AND DISPLAYING INTERACTIVE CONTENT AND ADVERTISING,” filed on Aug. 8, 2007, the entire content of which is hereby expressly incorporated by reference.

### FIELD OF THE INVENTION

The embodiments of the present invention relate generally to managing data, and more specifically to a system and method for managing links and digital assets in consumer products.

### BACKGROUND OF THE INVENTION

Multimedia and other data content are typically distributed on storage mediums such as a USB Stick, CD, VCD or DVD, and have traditionally been viewed and listened to on a television set, monitor, personal computer, or the like. The Internet has added the ability to locate content by a uniform resource locator (URL). Usually, data, audio and video content stored on specific media are organized by hierarchical menus and can be accessed selectively. stored on specific media are organized by hierarchical menus and can be accessed selectively. Content in World Wide Web (WWW), however, is often stored in more than one location and one type of storage media. Therefore, in order to present a complete user experience, related content must first be identified and then selectively accessed using an appropriate media player or storage device before the user is presented with the content.

Advertising on the Internet is a source of revenue for an increasing number of websites and companies. The use of rich media and static images is particularly popular in Internet advertising (online advertisements). Rich media ads are becoming increasingly popular generally using Macromedia Flash™. Rich media advertising utilizes color, imagery, page layout, and other elements to attract the reader's attention. Some examples of rich media ads include “banner ads.” A banner ad is typically a standard image displayed on a website. Banner ads come in numerous sizes, but are often rectangular. In addition, ads containing streaming video or streaming audio are becoming popular with advertisers.

An ad server is typically a computer server that stores advertisements and delivers (serves) them to website visitors. Ad servers typically include local ad servers and third-party or remote ad servers. Local ad servers are typically run by a single publisher and serve ads to that publisher's domains, allowing customization, creative formatting, and content control by a specific publisher. Remote ad servers typically serve ads across domains owned by several publishers. Remote ad servers send the ads from one central source so that advertisers and publishers can track the distribution of their online advertisements, and have centralized location for controlling the rotation and distribution of their advertisements across the web.

Furthermore, affiliate marketing on the Internet is a form of advertising on the Internet where the advertiser allows a potentially large number of small publishers to pick specific creative elements or offers to market in exchange for payment should such marketing create sales or other revenue.

Web based traffic is based on individuals finding web sites using navigation tools like search engines or learning of the web site from advertising. In order to increase site traffic and thereby ad revenues, content of interest to users must be developed to attract users and encourage users to return to the web sites.

### SUMMARY

The embodiments of the invention include a memory device and system for managing links to content or digital assets in an on-line, network or software application environment. The links and digital assets may be represented by unique identifiers and pointers or similar data. The memory device can take the form of a piece of jewelry, handheld game device, memory stick, toy or similar item. The memory device can include communication ports to provide connectivity to multiple devices including other memory devices, computers and similar electronic devices. The memory device can also include an input mechanism that allows a user to select an output of the memory device. The memory device can include a sensor or similar component that detects and receives non-digital input. The non-digital input can come from any source including sources embedded within pieces of jewelry, toys, electronic devices or similar items. The non-digital input can be received and stored as a digital value or used to modify an existing digital value. The memory device and system enable processes for transferring data between the memory device and other electronic devices, receiving non-digital input and handling input to select an output of the memory device.

### BRIEF DESCRIPTION OF THE DRAWINGS

FIG. 1 is an exemplary block diagram of a system operative in accordance with one embodiment of the invention;

FIG. 2 is a schematic representation of an exemplary memory device including one or more identifiers and one or more pointers, according to an embodiment of the present invention;

FIG. 3 is an exemplary flow diagram, according to an embodiment of the present invention;

FIG. 4 is an exemplary block diagram depicting the creating of a pointer to be embedded in a memory device, according to one embodiment of the present invention;

FIG. 5 illustrates an exemplary process flow for creating a user in a server according to one embodiment of the present invention;

FIGS. 6A and 6B depict two simplified hand handshake protocols between a memory device and a computer to modify or launch content, according to some embodiments of the present invention;

FIG. 7 is an exemplary process flow diagram showing a server basic process for receiving and executing a pointer, according to one embodiment of the present invention;

FIG. 8 is an exemplary block diagram depicting the retrieval of a content pointed to by a pointer embedded in a memory device, according to one embodiment of the present invention;

FIG. 9 is a more detailed exemplary process for selecting a pointer source, according to one embodiment of the present invention;

FIG. 10 is a more detailed exemplary process for applying pointer source permissions, according to one embodiment of the present invention;

FIGS. 11A, 11B, and 11C are exemplary process flows for executing the pointer payload processor, according to one embodiment of the present invention;

FIGS. 12A-12I show exemplary data table for batches, Group Permission, Overrides, Pointers, Users, User Groups, Groups, Processors, and Processor Properties, according to one embodiment of the present invention;

FIG. 13 is a more detailed exemplary process for executing a pointer payload process, according to one embodiment of the present invention;

FIG. 14 shows an exemplary process for selecting an ad banner, according to one embodiment of the present invention;

FIGS. 15A and 15B show exemplary batch processing; and

FIGS. 16A and 16B show exemplary batch processing with overrides.

FIG. 17 is a diagram of one embodiment of a memory device.

FIGS. 18A-C are diagrams of one embodiment of a memory device in the form of a locket and necklace.

FIGS. 19A and 19B are diagrams of one embodiment of a chain necklace and individual link.

FIGS. 20A and 20B are diagrams of one embodiment of the memory device in the form of a pen.

FIGS. 21A and 21B are diagrams of one embodiment of the memory device in the form of a bracelet.

FIG. 22 is a diagram of one embodiment of the memory device in the form of a handheld game device.

FIG. 23 is a diagram of one embodiment of the memory device in the form of bracelet and a non-digital modifier figurine.

FIG. 24 is a flowchart of one embodiment of a process for transferring data between memory devices.

FIG. 25 is a flowchart of one embodiment of a process for output selection.

FIG. 26 is a flowchart of one embodiment of a process for handling non-digital input.

FIGS. 27A and 27B are diagrams of embodiments of a memory device in the form of a greeting card and card holder.

FIG. 28 is a diagram of one embodiment of a memory device in a journal or photo album.

FIG. 29 is a diagram of one embodiment of a memory device in a plush toy.

### DETAILED DESCRIPTION

In one embodiment, the system of the present invention includes a themed memory device which inserts into a port (for example, a USB port) of a computing device, for example a personal computer (PC), pocket PC, cell phone, digital music player, a game console, and the like. The memory device is themed (or placed in a themed object) and economically designed in a wide variety of interesting shapes or representations, such as, a heart, a phone, a character, an animal, a toy, a greeting card (or a component thereof), a wearable item, such as a bracelet, necklace, or ring, a soft drink bottle, soccer ball or a flag. The memory device is designed to be used many times and passed around between friends or business associates.

In one embodiment, the themed memory device includes a memory chip with associated drivers, one or more unique identifiers (UIDs), and one or more pointers embedded on the chip with software. The one and/or more UIDs and pointers may invoke one or more specific websites, and/or launch one or more specific applications.

In one embodiment, the themed memory device is associated with a website (for example, myclickables.com™), which allows a user (e.g., a device holder) to download widgets or similar interface applications that increase the functionality of the device. A widget (or control) is typically a user interface that a user interacts with, such as a window or a text box.

In some embodiments, when inserted into the port, the themed memory device automatically points the user's web browser to a pre-designated website (a publisher's website). In one embodiment, the pre-designated website serves an ad, such as a banner ad that is displayed with the content that the pointer embedded in the memory device is pointing to. In one embodiment, the ad is displayed with a framed webpage displaying the content. The ad can be modified by the user or served by a sponsor relationship.

In some embodiments, a software application or a second content may be displayed instead of, or in addition to the ad. In one embodiment, the ad or the content impressions and clicks are stored and made available to determine additional user demographic information which may be tracked and reported.

In one embodiment, a desktop application reads one or more unique identifiers (UIDs) and one or more pointers from a memory device. Based on the UID(s) and/or pointer(s), the desktop application retrieves a redirect pointer from a pointer database (table). The desktop application then follows the redirect pointer by launching a software application. In another embodiment, the unique identifier or pointer is used to access content without use of a redirect pointer. The desktop application then displays the results of the launched software application along with an advertisement selected from a number of different advertisements. The ads include predetermined content and may be displayed randomly, or based on different criteria.

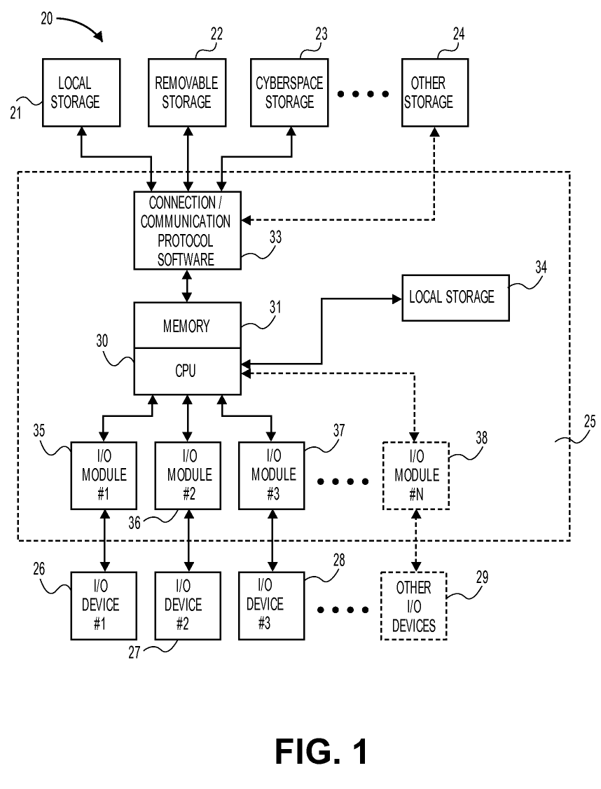

FIG. 1 is a block diagram of a system 20 operative in accordance with one embodiment of the invention. The system includes a processor 25 represented by a dotted line. The processor, illustratively, comprises a computer with a CPU 30 and memory 31 with various I/O modules 35, 36, 37, 38 and connection/communication protocol software 33 with local storage 34 which could reside in memory 31.

Various storage mediums 21, 22, 23, 24 representing local PC storage medium, removable storage medium, cyberspace storage medium and other storage medium respectively, are operative under the control of the connection/communication protocol software. Similarly, various I/O devices 26, 27, 28,29 are connected to I/O modules 35, 36, 37,38 respectively.

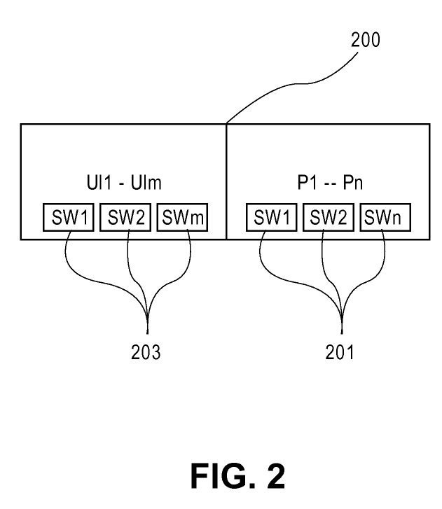

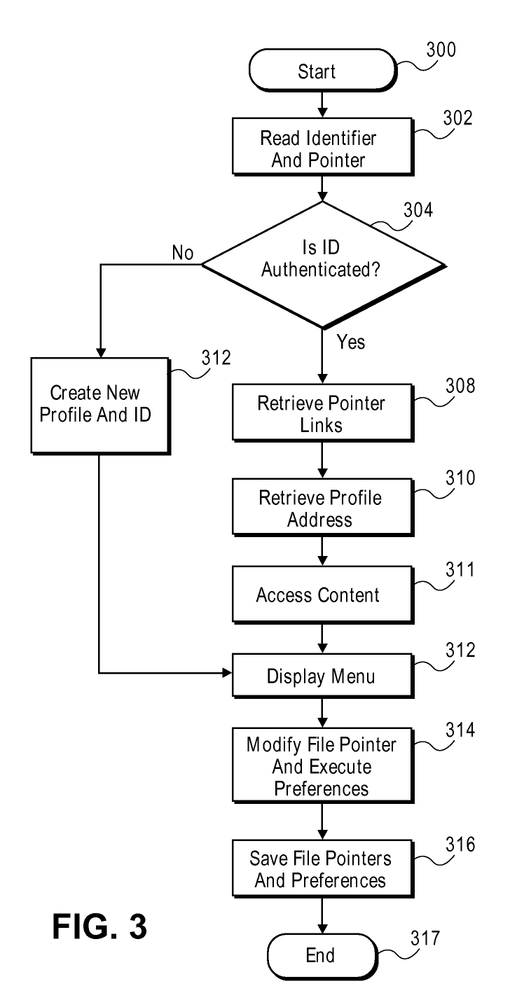

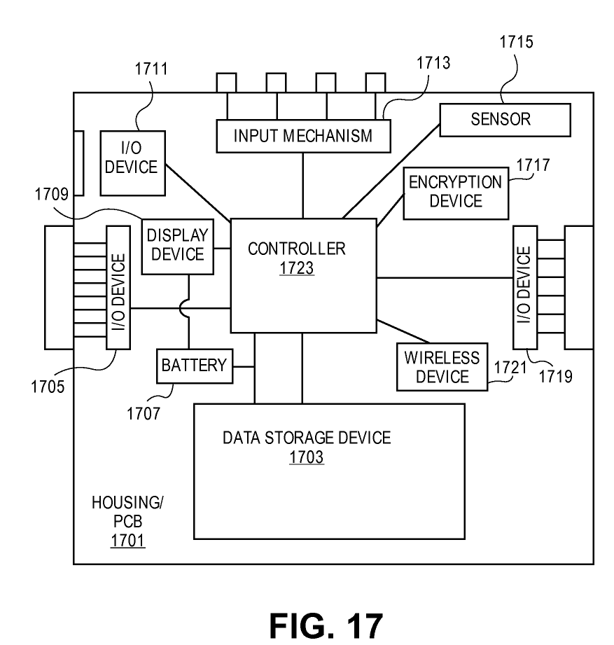

FIG. 2 is a schematic representation of a memory device 200 with one or more identifiers UI1, . . . UIm and a plurality of pointers P1, . . . Pn. The memory device includes one or more switches indicated at 201 and 203. Switches 201 are user operative to select a particular pointer and switches 203 are user operative to select a particular identifier. Thus, in the embodiment of FIG. 2, the user is able to selectively choose one or more identifiers and one or more pointers. The memory device 200 of FIG. 2 may be used for accessing a system, for example, the system of FIG. 1. The memory device is read by a reader, such as the I/O device 26 in FIG. 1 and software 33 of FIG. 1, and responds as described in connection with the flow diagram of FIG. 3. Another embodiment of the memory device is described in regard to FIG. 17.

The software is invoked when a memory device is read by a reader or a software application, as indicated at 300 in FIG. 3. The identifier (UID or UI) in the memory device is read as indicated at 302. If the identifier UID (UI and UID are used interchangeably in this document and mean the same) is already stored in the system, it is authenticated in 304. The pointer (P) in the memory device is then allowed to link to (retrieve) the profile address at which the locations of files related to the identifier are stored, in block 308. In block 310, the profile address is retrieved from a remote database, or locally. The files/content addressed by the profile are then accessed and executed as indicated at 311.

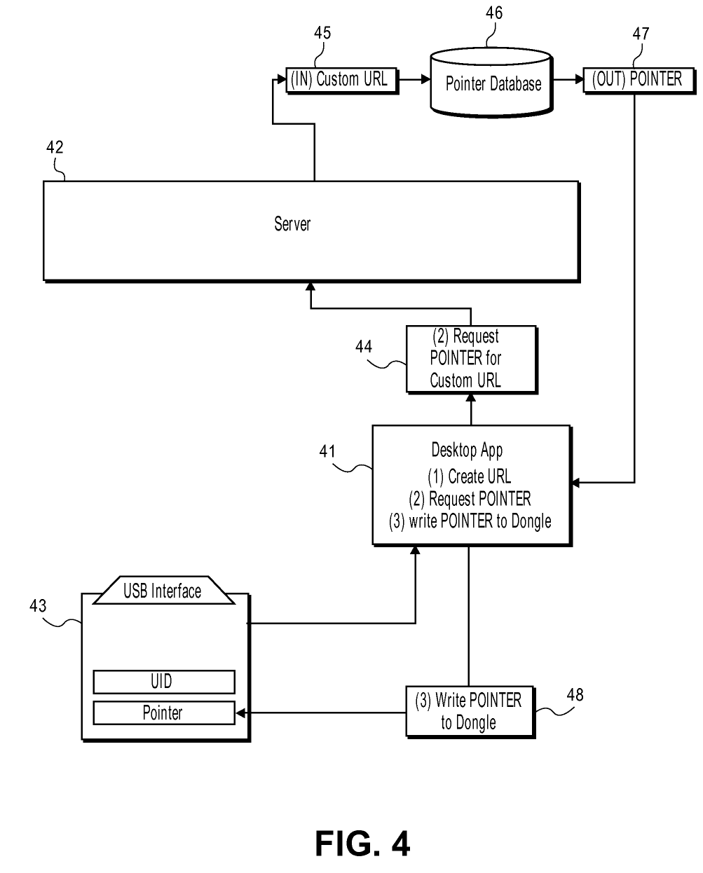

In one embodiment, the system and method of the present invention creates one or more pointers embedded in the device. FIG. 4 is an exemplary block diagram depicting the creating of a pointer to be embedded in the themed memory device, that is programming the memory device according to one embodiment of the present invention. The pointer creation process includes a desktop application 41 with Internet access, a server 42, and a connected device 43. Although a USB memory device (dongle) has been used as an example for the themed memory device to demonstrate the functionality of the present invention, as one with ordinary skill in the art of computer memory would easily realize, the memory device is not limited to a USB dongle and may include different types of pluggable memory devices.

An exemplary process for creating and embedding one or more pointers in the memory device is now described. First, a valid custom URL 44, for example, a simple webpage link is manually entered by the user, or a URL previously returned by the server and unseen by the user is acquired. Then, the desktop application requests a pointer from the server, passing the custom URL as one of the parameters 44. The server then adds the custom URL 45 to a Pointer Database 46 and returns to the desktop application 41 a pointer 47 to the custom URL. In one embodiment, the returned pointer includes additional embedded tags which can modify the presentation of retrieved data pointed to by the pointer. The pointer returned to the client application is then stored 48 in the connected (USB) themed device 43. The same pointer may also be written into any number of themed memory devices.

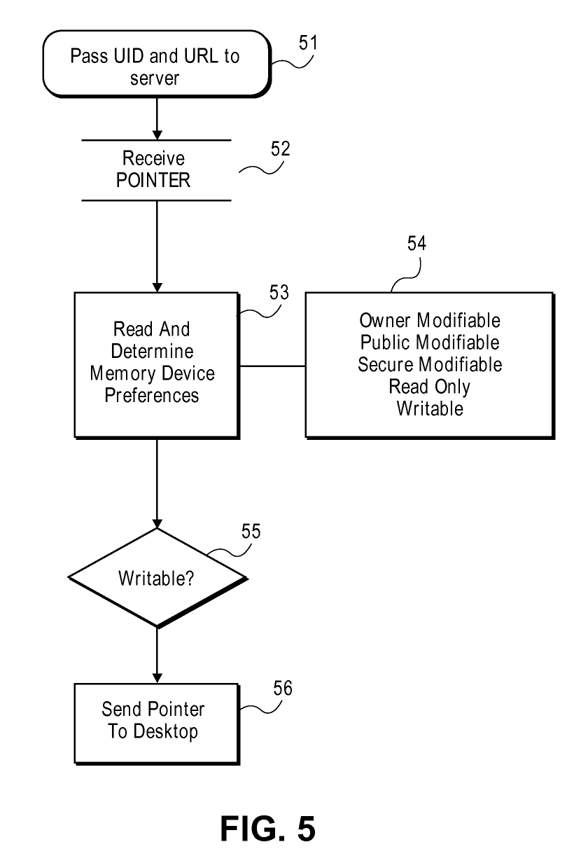

FIG. 5 illustrates an exemplary process flow for creating a user in the server according to one embodiment of the present invention. The memory device is connected to a reader and the UID and pointer are passed to the server 51. The server receives the pointer (52) and then reads the pointer and determines if there are any preferences (53), such as owner modifiable, public modifiable, secure modifiable, read only, or writable (54). If the pointer is writable (55), the pointer is sent to the desktop application and the pointer field is written (56).

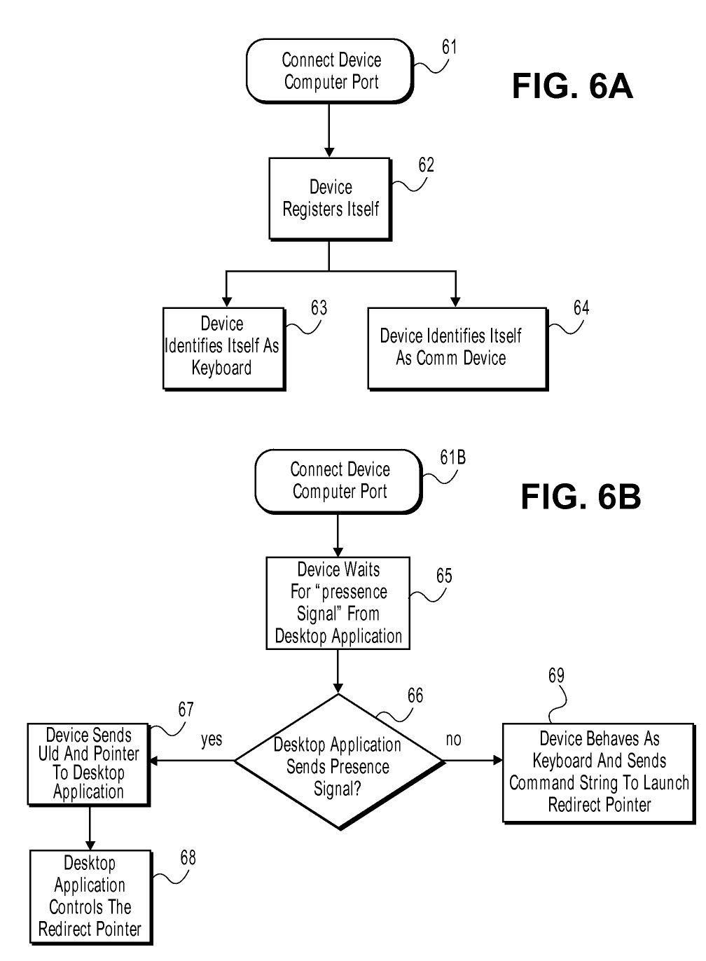

In one embodiment, when the memory device is connected to a port of a computing device, it goes through a hand shake protocol. FIGS. 6A and 6B depict two simplified hand handshake protocols between the memory device and the computer to modify or launch content, according to some embodiments of the present invention. Referring to FIG. 6A, when the memory device is connected to a port of the computer (61), the device registers itself (62), identifies itself as a keyboard (63) or as a communication (COMM) device. For example, an application software may be downloaded or a specific re-direct pointer stored in the device may be auto-launched.

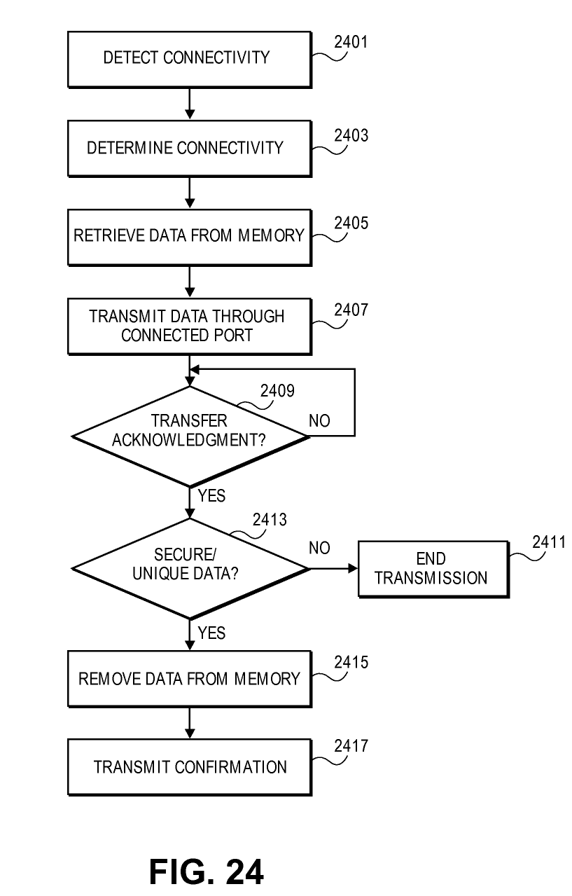

Referring now to FIG. 6B, when the memory device is connected to a port of the computer (613), the device waits for a presence signal from the computer (65) and if it receives the signal, the device then sends the UID and the pointer(s) to the computer (desktop application) (67). The desktop application then controls the redirect pointer, as shown in block 68. If the memory device does not receive the presence signal from the computer, it behaves as a keyboard and sends a command string to the computer to launch an application, e.g., browser, as shown in block 69. The presence signal may be queried from a server, a local computer, or the memory device itself. The process for communication between memory devices is described below in regard to FIG. 24.

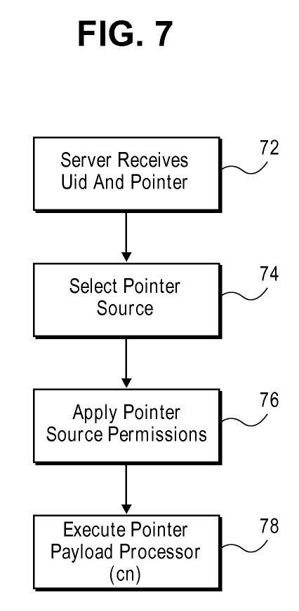

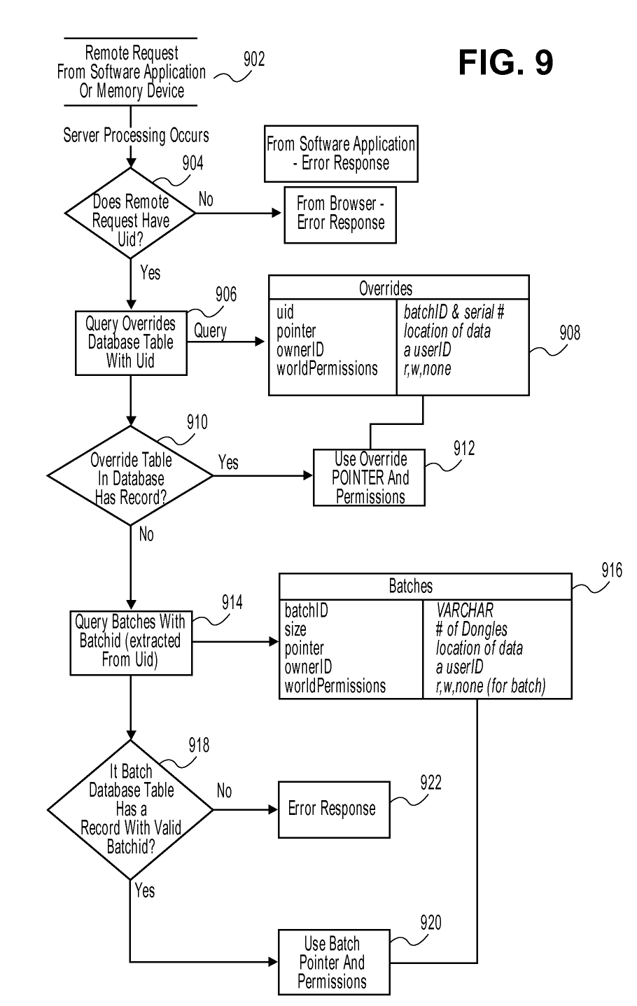

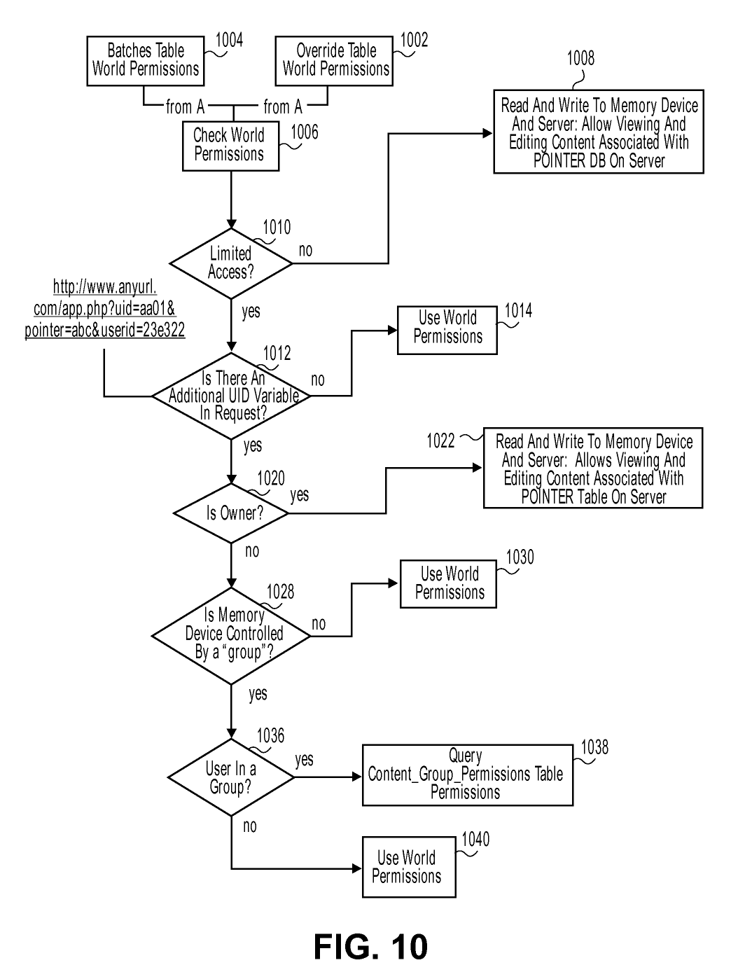

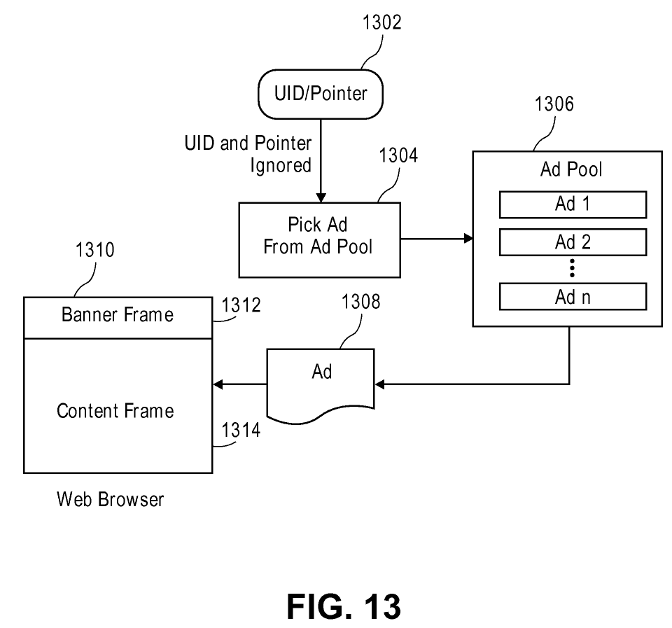

FIG. 7 is an exemplary process flow diagram showing a basic server process for receiving and executing a pointer, according to one embodiment of the present invention. In block 72, the server receives the UID and the pointer from the themed memory device. The server then selects the pointer source from pointer database in block 74. A more detailed exemplary process for selecting a pointer source is illustrated in FIG. 9. The server then applies pointer source permissions from the pointer database, if applicable, as shown in block 76. A more detailed exemplary process for applying pointer source permissions is shown in FIG. 10, according to one embodiment of the present invention. In block 78, the server then executes a pointer payload process to execute a pointer, for example, launch an application, a game, visit a website, play a song, and the like. A more detailed exemplary process for executing a pointer payload process is shown in FIG. 13, according to one embodiment of the present invention.

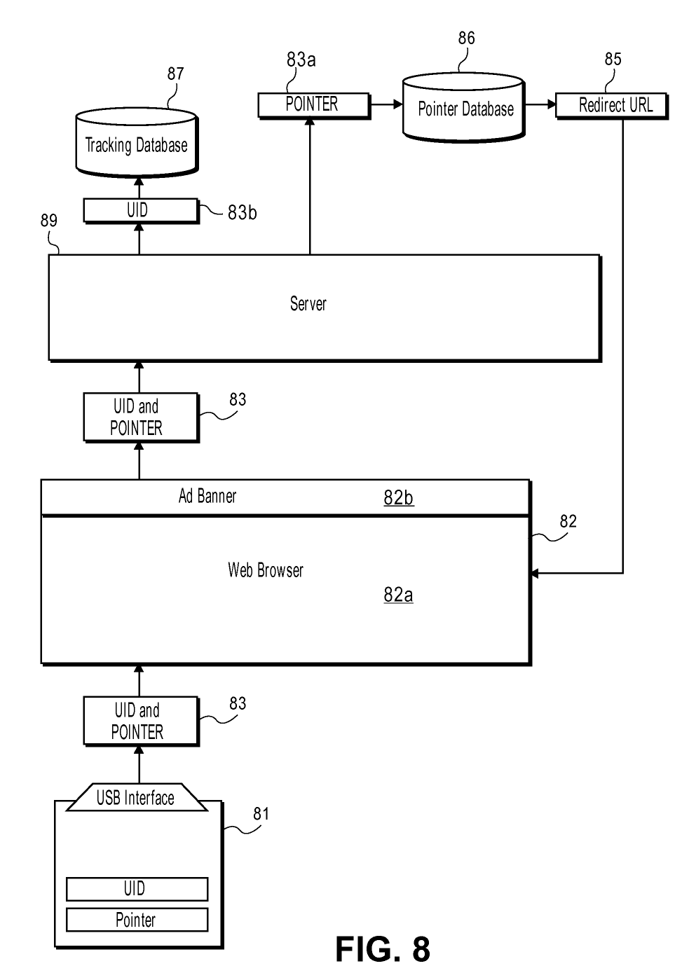

FIG. 8 is an exemplary block diagram depicting the retrieval of a content pointed to by the pointer embedded in the themed device, according to one embodiment of the present invention. First, the user connects the themed memory device 81 to, for example, a PC 82 including a web browser 82a. In response, the PC launches a web browser program and instructs the web browser to connect to a predetermined server 84 (for example, Myclickables.com™ server). The server obtains the UID(s) and the pointer(s) 83 from the memory device and retrieves a (redirect) URL 85 from the pointer database 86, according to the obtained UID(s) and the pointer(s). The server also extracts any tags that may be embedded with the pointer 83a. Utilizing the URL and the tags (if any), the server then returns the redirect pointer 85. A Tracking (statistics) database 87 pointed to the UID 83b stores all the relevant information for the users and the content and/or an ad (if one is displayed) usages.

In one embodiment, the web based content is displayed with for example, a horizontal banner 82b in a locked web frame at the top of the browser window. The source and tracking of web banner content can be associated with batches of UIDs (explained below) and/or single UIDs. The type and format of web banner content is not limited in any way and therefore can use and adhere to a variety of ad services, content and/or software applications executable via the browser.

In one embodiment, an ad is stored in a server as a text block which is inserted into the banner frame document when the banner frame is served to the user. The text block contains valid HTML or JavaScript to render the ad. Examples of ads include an ad as simple as an image reference with a link or as complex as a javascript game. The media (if any) associated with an ad can be stored on the publisher's servers, some other remote servers, or edge caching servers. The media URL(s) is included in the ads text block.

Although some exemplary embodiments of the invention disclose selecting and displaying an advertisement with a content, the present invention is not limited to selecting and displaying an advertisement. For example, another content and/or a software application may be displayed along with the first content (or the publisher's website information).

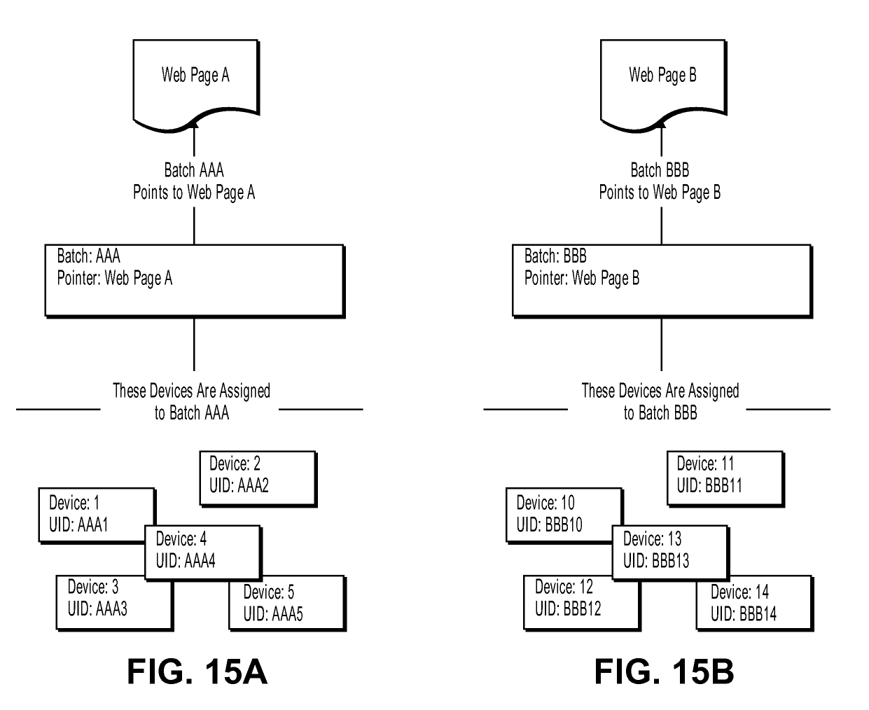

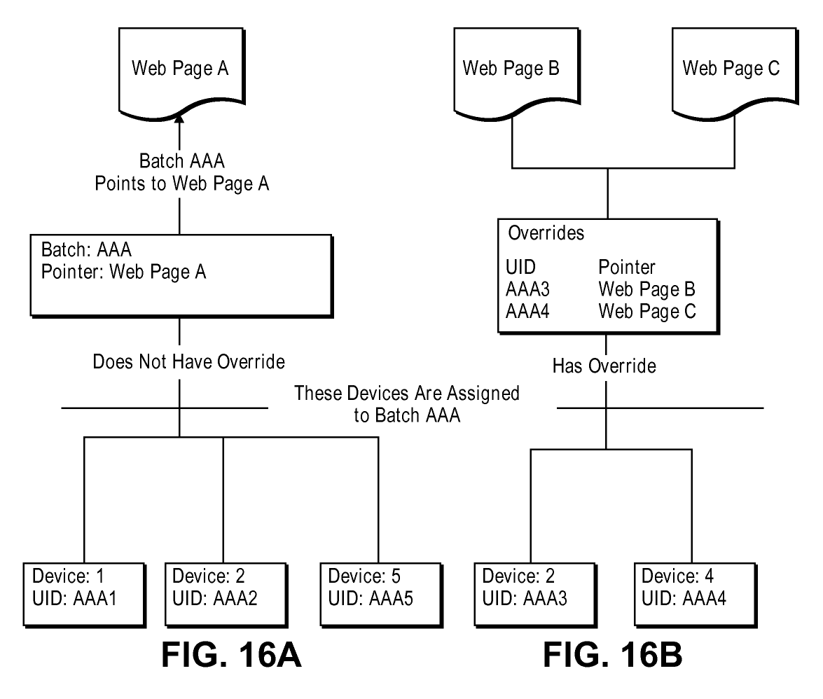

In one embodiment, each memory device may be part of a “batch” of memory devices. See FIGS. 15A, 15B, 16A and 16B in reference to the use of batches. In other words, a batch is a grouping of two or more memory devices. A batch ID, which may be a fixed string of alphanumeric characters may be embedded in a pointer. In one embodiment, the UID embedded in the memory device comprises a batch ID and a serial number (code). For example, aaaa1, aaaa2, and aaaa3 are respectively UIDs 1, 2, and 3 from the batch “aaaa.”

For instance, batches may be groups of memory devices assigned to a particular affiliate, vendor, and/or user. Every batch of memory devices has a Pointer and use permissions, which are used to determine what the memory devices in a batch will display or do, and who can see, use, or modify them. All memory devices have a UID which includes information about the batch to which they belong. When a user uses a memory device, the batch information is extracted and used to retrieve that batch's Pointer. The Pointer points to the content and/or behavior the user will receive.

For example, a particular company may buy a lot of 10,000 memory devices. Each device in that lot will be assigned to the same batch by having the batch's ID written into its UID. The company can then configure the batch Pointer to point to URL on their website. When a user uses one of those memory devices, the batch information in that memory device's UID is used to retrieve the batch Pointer which points to a particular page on the McDonalds' website.

In one embodiment, different memory devices in a given batch can point to different content and/or behavior. This is accomplished with an “override” operation. An override is the assignment of an alternate Pointer to one or more memory devices in a Batch.

In one embodiment, an “override” permission allows for specific treatment of a subset of a batch. For example, if there are 10 unique memory devices in Batch AAA, a content creator may change 5 unique batches out of Batch AAA. The override permission allows for unique behavior of these 5 specific memory devices in Batch AAA. For instance, 50,000 memory devices can be sold to a large retail company X, that is, Batch AAA includes 50,000 units. Company X then sells five of the units to a consumer and the consumer desires to modify his memory devices to launch his personal webpage on the browser. The consumer then uses software, according to embodiments of the present invention to modify the already embedded Company X pointer to his personal webpage through the override permission. In this case, the publisher's website can provide tracking data for both the batch owner (the consumer) and the override owner (Company X).

In one example, consumers purchase the themed memory devices from a website or from a retail store. A user accesses the publisher's website (for example, myclickables.com™) and creates a pointer for the device to point the memory device to a favorite website or specific web page the user selects. When the user plugs in the memory device with the embedded pointer activated, the pre-selected web page appears. In one embodiment, the pre-selected web page includes a banner ad served by a publisher's server.

In another example, a company may purchase several soccer-themed memory devices. Each one of the company's memory devices is pre-set to take the user to a company soccer site with a special company soccer ad banner displayed on the users screen. The company memory devices may be given away for free at company stores with a purchase. The user can set a new favorite web page by re-programming the embedded pointer in the device and give it to a friend. The new favorite web page is still framed with the company banner ad when the user inserts the soccer-themed memory device into a computer port. The displayed banner ad disappears when the user accesses another web page with the browser.

FIG. 9 illustrates an exemplary process flow for retrieving a pointer, according to one embodiment of the present invention. When a remote request from a software application or a memory device is received by the server (902), the server checks to see if the request includes a UID (904). If the request includes a UID (906), the server checks an override database (table) 908 to see whether there is an override record in the database for this UID (910). If there is an override record in the database for this UID, the server retrieves the override record and associates the relevant override rights to the memory device and generates a pointer based on the override pointer and the corresponding permissions in the override database and use that pointer and the associated permissions (912).

If there is no override record in the database, the server checks (914) a batch database (table) 916 to see if there is a batch record in the batch database 918. If there is a batch record in the batch database, the server uses the batch pointer and the corresponding permissions to generate the pointer, as shown in block 920, if not, an error message is sent (922).

In one embodiment, the method and system of the present invention includes groups. Groups are a way for users to control who can see/use/modify their memory devices. Users can belong to multiple groups and can create groups for their own memory devices. For example, let's assume Toy Co. buys 10,000 memory devices which point to a promotion page. Toy Co. then creates a “members only” group which users can join by visiting the promotion page. Users who have not joined the group will see the promotion page. Users who have joined the group will be redirected to another web page. In another example, a user creates a slide show, which she wants to share only with a select group of friends. The user thus creates the group and adds the select group of friends to her group. She then passes out the memory devices and only users who have been added to her group will be able to view the slide show.

FIG. 10 is an exemplary process flow for pointer permissions, according to one embodiment of the present invention. The server checks (1006) the type of permission from the batch table (1004) and/or override table (1002). If there is no limitation on the access rights, the server provides viewing and editing rights to the pointer(s) in the pointer database (1008). If there is a limited access right, the server checks to see if there is an additional UID variable in the request (1012). If there is no additional UID variable, the server checks the batch table and override table using the limited access permissions (1014).

If there is an additional UID variable in the request, the server determines if the additional UID belongs to an owner (1020). If it does, the server provides viewing and editing rights to the pointer(s) in the pointer database (1022). If there is no additional UID variable in the request, the server checks to see if the memory device is controlled by a group (1028). If the memory device is not controlled by a group, the server checks the batch table and override table using the limited access permissions (1030). If the memory device is controlled by a group, the server checks to see if the user is in that group (1036). If the user is in the group controlling the memory device, the server queries a Group Permission table (1038) to determine permission rights. If the user of the memory device is not in the group controlling the memory device, the server checks the batch table and override table using the limited access permissions (1040).

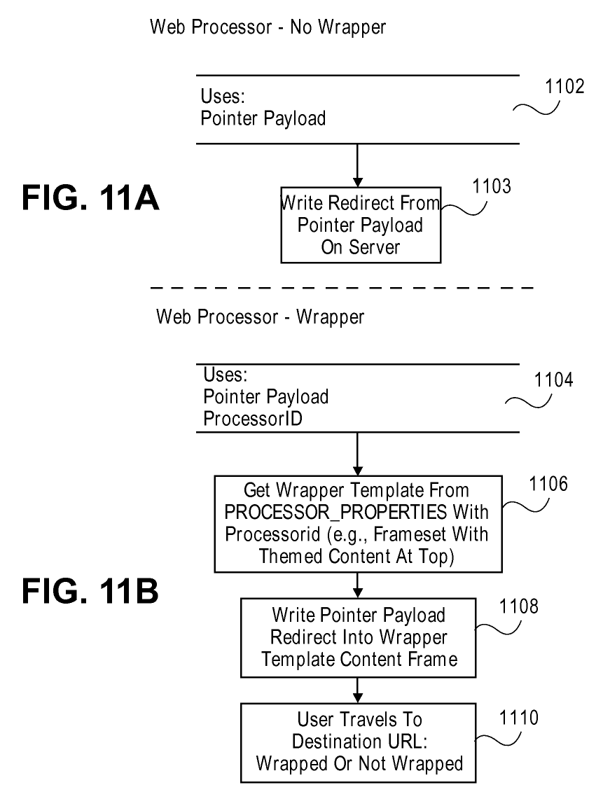

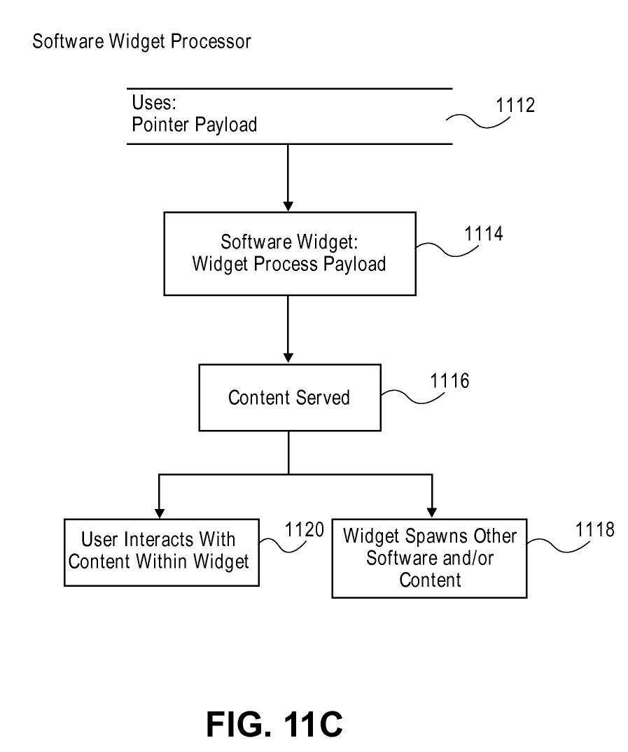

FIGS. 11A, 11B, and 11C are exemplary process flows for executing the pointer payload processor, according to one embodiment of the present invention. FIG. 11A depicts an exemplary process flow when there is no content wrapper.

FIG. 11B shows an exemplary process flow when there is a content wrapper and FIG. 11C illustrates an exemplary process flow when there is a widget processor. In one embodiment, every Pointer is composed of some data, and some behavior. The simplest case is where a Pointer represents a page on a web site. The data is the URL of the page, and the behavior is the server redirection to the URL. A Processor is the behavior portion of a Pointer.

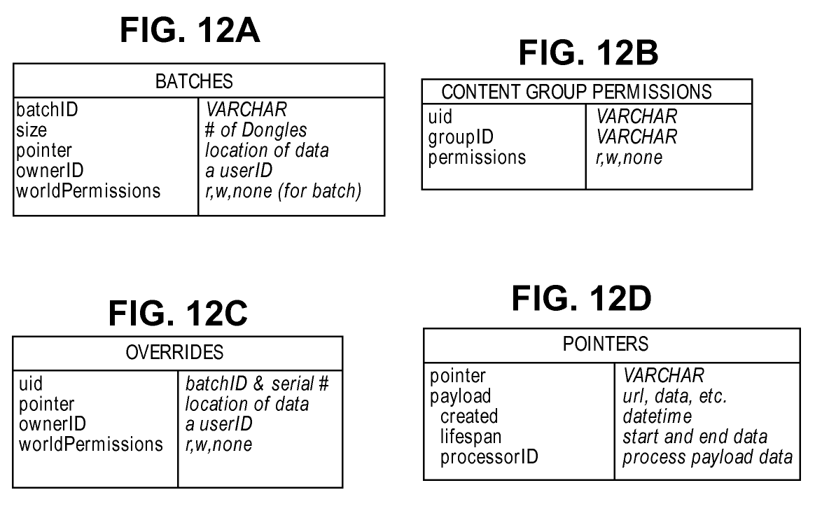

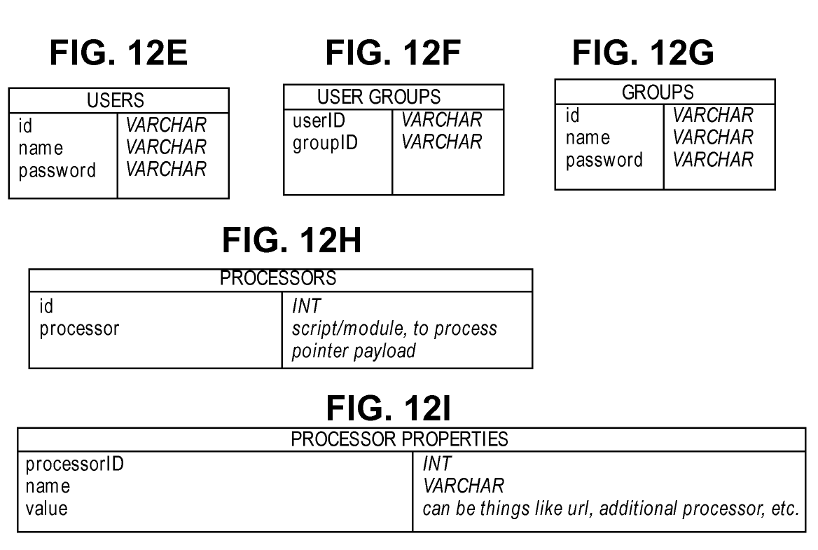

FIGS. 12A-12I show exemplary data table for batches, (12A), Group Permission (12B), Overrides (12C), Pointers (12D), Users (12E), User Groups (12F), Groups (12G), Processors (12H), and Processor Properties (12I), according to one embodiment of the present invention.

In one embodiment, the content of the ad banner comes from a rotating ad pool (for example, in the server) with no additional UID or Batch selection applied. FIG. 13 is an exemplary block diagram showing the selection of an ad, according to one embodiment of the present invention. As shown in this example, the UID(s) and the pointer(s) 1302 are ignored by the server for the purpose of selecting the ad. In this embodiment, the ad is selected (1304) from an ad pool/database 1306 based on factors other than UID and pointer. Text may be added to the selected ad (not shown) and the selected ad 1308 is then displayed in the browser 1310. In one embodiment, the displayed ad in the browser may include a banner frame 1312 and a content frame 1314. Here, the ad may be selected randomly, based on themes, for example, sports, politics, movie genres, and the like. The ad may be static or dynamic.

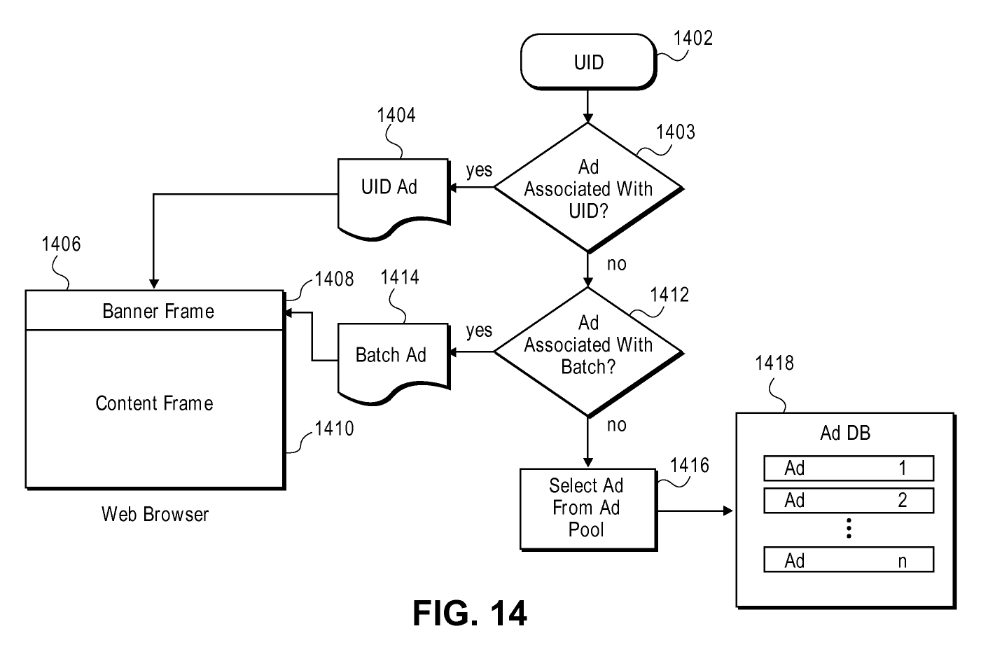

In one embodiment, the ad banner is selected based on the batch and/or the UID, as shown in FIG. 14. As shown, if the ad is associated with the UID 1402 embedded in the themed memory device (1403), an appropriate ad is selected from the ad database 1418. The selected ad 1404 is then displayed with the content in a browser 1406. For example, the ad may be related to the content addressed by the pointer or the application executed by the pointer.

If the ad is associated with a batch specified in the themed memory device (1412), an appropriate ad is selected from the ad database. The selected ad 1414 is then displayed with the content in the browser 1406, as shown in FIG. 14. For example, a batch-based ad may be a gift dongle from a retailer. In this case, although the UID may be unique to each user, the entire batch of the UIDs may be related to one specific entity, company or retailer. In one embodiment, the displayed ad in the browser may include a banner frame 1408 and a content frame 1410.

In one embodiment, the ads are targeted based on the type of content a device is requesting (for example, URL of the content frame), by the type of desktop widget the device uses, or by the physical characteristics of the device itself. In one embodiment, an ad includes an “ad text block” and the ad targeting does not apply if the UID or Batch has an ad text blocked associated with it.

In one embodiment, a second content and/or a software application is displayed instead of or in addition to the ad.

In one embodiment, the server tracks different metric such as Number of themed memory devices in circulation by device, widget, and content; number of unique users of device, widget, and content; and standard web usage metrics such as visitors, unique visitors, and views.

FIG. 17 is a diagram of one embodiment of a memory device. This diagram is a more detailed view of the memory device illustrated and described above in regard to FIG. 2. In one embodiment, the memory device is disposed on a printed circuit board 1701 within a housing or on a similar substrate within a similar packaging. In another embodiment, any number of the components of the memory device may be on separate substrates or not attached to substrates. The memory device may have any shape or size. In one example embodiment, the memory device has a form factor of a memory stick that is roughly rectangular with a length between one inch and three inches, a width between 0.1 inches and two inches and a depth between 0.1 inches and one inch. This form factor is provided by way of example and for the sake of clarity in describing an embodiment of the invention. Other example form factors are described below and one skilled in the art would understand that the principles and features of the described embodiments are applicable to other shapes, form factors and sizes.

The memory device includes a controller 1723. The controller 1723 can be an application specific integrated circuit (ASIC), a general purpose processor or a similar processor or controller. The controller 1723 manages the movement of data between the other components of the memory device and also drives the other components of the memory device. In one embodiment, the controller 1723 may also incorporate some or all of the other components of the memory device. For example, the controller may include a data storage device 1703, I/O communication devices or similar components.

The memory device includes at least one storage device 1703. The storage device 1703 can be any type of persistent storage device. The persistent storage device 1703 can be an electronically erasable programmable read only memory (EEPROM), flash storage device, static random access memory (SRAM) device or similar persistent storage device. The storage device 1703 can have any size and hold any amount of data dependent on the storage requirements of the memory device. In another embodiment, an additional storage device of any type or size can be included. The additional storage devices can be used to hold separate types of data, provide additional space or facilitate a simpler design. For example, separate storage devices can be tied to separate input mechanisms to be output by the memory device upon selection of a corresponding input device.

The storage device 1703 may store any type of content, links, digital assets or similar type of data. A link may be any type of pointer or identifier to a data storage location (e.g., a web site as discussed above). In one embodiment, a link may be a universal resource locator (URL) or a portion thereof. In another embodiment, the link is a pointer used to retrieve a URL or similar identifier. The URL identifies a location of data, such as a document, web page, or media file, on a network or system, including within the World Wide Web or Internet. The link may be to theme based content associated with the memory device. A digital asset is virtual item, digital recording (e.g., audio/visual recording), avatar or attributes or characteristics of such items. The digital asset may be a unique item that must be managed securely, an item subject to a digital rights management (DRM) scheme or similar item. Examples of digital assets include but are not limited to: theme based content, a virtual item from an on-line world or a software application, a digitally recorded song, a digitally recorded movie or television show, an avatar, a game score or achievement or similar items. In another embodiment, the digital asset is a UID and/or pointer to identify the items described above.

Links and digital assets may be tied to a particular on-line world, network application or local software application. For example, a link or digital asset may be tied to a massively multiplayer on-line (MMO) game, where a link provides access to an area of the MMO world and the digital asset is an item in such a world. Links and digital assets may be represented and stored in the memory device using any format or data type including the use of the unique identifiers and pointer system discussed above.

The memory device may include a battery 1707. Any type of battery including an alkaline, lithium-ion, nickel-cadmium, nickel metal hydride or similar types of batteries can be utilized. The battery 1707 provides a power source for the components of the memory device. In another embodiment, the battery 1707 may be replaced or assisted by other power sources such as external power sources, photovoltaic cells or similar power sources. The housing may be configured to allow easy replacement of the batteries 1707.

The memory device may include any number of input/output (I/O) devices 1705, 1711, 1719. A first I/O device 1705 can be any type of communication port, protocol or medium. The first I/O device 1705 may be a universal serial bus (USB) port, FireWire port, serial port, parallel port or similar communication port. The first I/O device 1705 can be connected to any type of physical connector or dongle. The connector can be a male or female connector such as a male or female USB connector. The second I/O device 1719 can be the same type of communication port and/or connector as the first I/O device 1705. The second I/O 1719 device can be used for chaining together multiple memory devices. Any number of I/O devices and communication ports can be provided to allow for chaining any number of memory devices together using any pattern. For example, the first I/O device 1705 and the communication port can be a male USB connection while the second I/O port 1719 is a female USB connection. This allows the memory device to be an intermediate link in a chain of memory devices.

A third I/O 1711 device may provide an alternate communication medium, connector type or medium from the first 1705 and second I/O devices 1719. For example, the first and second I/O devices 1705, 1719 may be utilized for chaining, while the third I/O device 1711 is utilized to connect to another type of devices such as personal computer, handheld game device or similar electronic device. The third I/O 1711 device can be of any type of communication port, connector, protocol or medium.

In one embodiment, any of the I/O devices or a separate I/O device may be a wireless device 1721. The wireless device 1721 can be any type of wireless device including a Bluetooth, 802.11 b/g/n, infrared (IR) or similar type of wireless communication device. All of the I/O devices can be utilized to transfer and receive data from other electronic devices including other memory devices, personal computers, console devices, handheld gaming devices and similar electronic devices.

The memory device can include an input mechanism 1713. The input mechanism 1713 can be any type of physical input mechanism connected to electrical components to generate electrical signals to be input into the controller 1723 or other components of the memory device. The input mechanism can be a set of switches, buttons, dials, touchpads or similar input mechanisms. A ‘set,’ as used herein, may refer to any positive whole number of items including one item. These input mechanisms 1713 can be used in combination or separately to generate input signals that are processed by the controller 1723 of the memory device. The input signals can be processed to select a data item such as a link or digital asset stored in the memory device to be output by the memory device.

The memory device can include a sensor 1715. The sensor 1715 can be any type of detection or sensing device. The sensor 1715 can be used to detect any non-digital input such as an electro-magnetic, kinetic, energy, light, mechanical or similar force. The sensor 1715 can be a resistor, conductive ink, voltmeter, ammeter, ohmmeter, thermometer, photodetector or similar sensor. The sensor 1715 may sample or similarly receive the non-digital input to generate an analog value or digital value representing the non-digital input. The sensor 1715 may include an analog to digital (A/D) converter or an analog signal may be passed to the controller 1723 or separate A/D converter. The controller 1723 either converts or receives a digital representation of the non-digital input. This non-digital input can be used to modify existing data or can be stored as new data.

The memory device may include an encryption device 1717. The encryption device 1717 provides security to the memory device by encrypting and decrypting data transmitted to or from the memory device or within the memory device. In another embodiment, the encryption device 1717 is a sub-component of the controller 1723. The encryption device 1717 may also facilitate the management of unique digital assets, links or DRM. The encryption device 1717 and/or controller confirm the transfer of unique links or digital assets to other electronic devices and delete the data from the memory device upon confirmed transfer.

In one embodiment, the memory device may include a display device 1709. The display device 1709 can be any type of display device including a cathode ray tube (CRT), liquid crystal display (LCD), light emitting diode (LED) or similar display type. The display device 1709 may include a graphics controller or the controller 1723 may drive the display device 1709. In one example embodiment, the memory device 1709 may take the form of a handheld gaming device where the display device 1709 is utilized to provide a game and the input mechanism 1713 is utilized to control the game. The memory device can include any number or size of display devices 1709 and the display devices 1709 may provide any resolution and color depth including black and white or grayscale based displays.

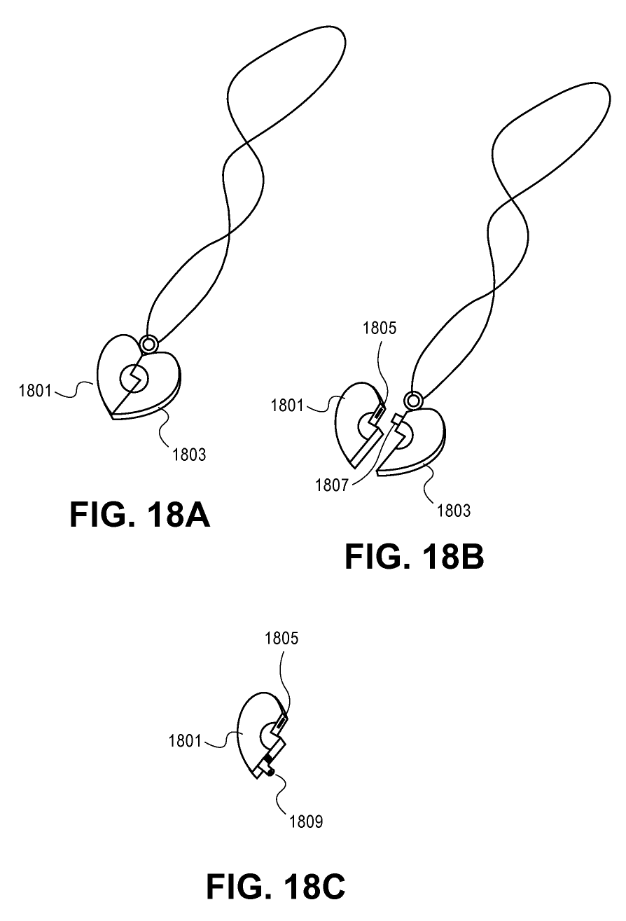

FIGS. 18A-C are diagrams of one embodiment of a memory device in the form of a locket and necklace. FIG. 18A shows the necklace in a complete form. The necklace includes a locket with two halves 1801, 1803. Each half of the locket is a complete functioning memory device. The locket halves may share data with one another including secrete codes, links, digital assets and similar data. The data may be synchronized or transferred between the halves of the locket 1801, 1803 when they are connected. The locket can have any shape or form. The shape or form may be based on a theme or franchise and the data stored in the locket such as links and digital assets may also be tied to the theme or franchise. For example, the owner of the locket may connect at least one half of the locket to a personal computer and log into an associated on-line social network where the user designs a home page or virtual home. The location or key to the page or home is stored in the locket. The owner can then give one half of the locket to a friend to give the friend access to the user created content.

FIG. 18B shows the locket halves 1801, 1803 separated form one another. The locket half 1801 includes at least one female or universal connector 1805, while the second locket half 1803 includes at least one male or universal connector 1807. The halves of the locket can be coupled together using any coupling mechanism including a snap-fit, form-fit, latch or similar mechanism. The locket halves 1801, 1803 may also be compatible with other locket or jewelry pieces to form new pieces of jewelry such as a charm attached to a necklace. The locket halves can also exchange data with other pieces in combination jewelry or accessories.

FIG. 18C is a diagram of one embodiment of the locket half 1801, where the locket half 1801 includes a second connector 1809. The second connector 1809 may be a male or universal connector type. The connector 1809 may be rotated or similarly moved from a deployed to an undeployed position to allow the locket half 1801 to connect with the other locket half 1803 and other electronic devices.

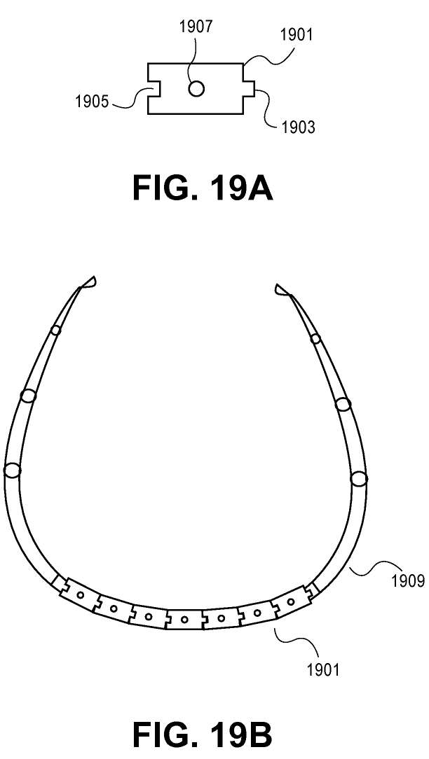

FIGS. 19A and 19B are diagrams of one embodiment of a chain necklace and individual link. FIG. 19A is a diagram of a memory device in the form of an individual link 1901. The individual link 1901 can have a first connector 1903 a second connector 1905 and an input mechanism 1907. The individual link 1901 is a memory device with any or all of the components described above. The housing of the individual link 1901 is formed for ornamental appeal as a piece of a necklace, bracelet or similar type of chain or accessory. The individual link 1901 includes multiple communication ports and/or connectors to allow the link to be coupled to and exchange data with any number of other devices. If the devices are coupled together in a link, then the data from any device can be shared or transferred to another device coupled to the chain. In one example embodiment, an input mechanism 1907 can be used to select a data item to be transmitted to connected devices in chain.

FIG. 19B illustrates an example embodiment where the links 1901 are connected to a frame or similar item to form another item such as a necklace 1909. The links 1901 can be chained together to create a chain or other item of any size. The links 1901 may also have coupling mechanisms to fasten themselves to one another and other items to form necklaces, bracelets, anklets and similar items. When combined the input mechanisms of the individual links 1901 may be used in combination with one another to select output from the chain as a combination of the data of the individual elements. Similarly, the combination of individual links 1901 and the use of input mechanisms 1907 may be used to unlock data or functionality. For example, combining a set of individual links and pressing the input mechanisms for a specific sub-set of the individual links can unlock data in any one or set of the individual links 1901.

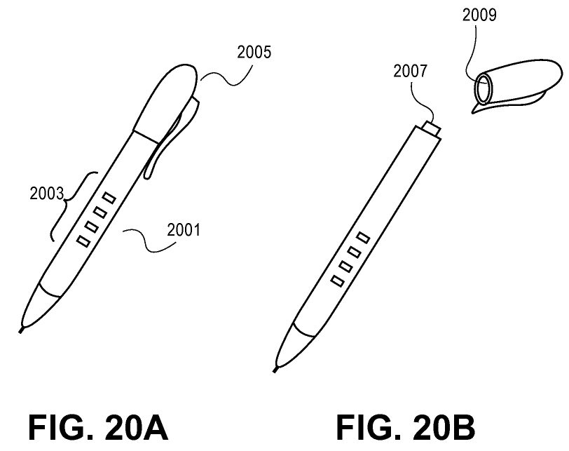

FIGS. 20A and 20B are diagrams of one embodiment of the memory device in the form of a pen. FIG. 20A is a diagram of the pen with a hidden connector. The pen 2001 includes a set of input mechanisms 2003 and a cap 2005. The set of input mechanisms 2003 can be used to select functionality of the pen 2001 and/or select output for the memory device within the pen 2001. The pen 2001 can have any type of writing functionality including multiple types of ink, retractable head, handwriting recording/recognition or other functions. The set of input mechanisms 2003 can be used to select the mode of operation of the pen 2001 or to input data into the pen 2001. For example, a secret code can be input into the pen 2001 to be stored within the memory device.

FIG. 20B shows the pen with the cap 2009 removed. The removal of the cap 2009 reveals a connector 2007 by which the pen can be connected with other electronic devices and used to transfer data or receive data including links and digital assets. In one embodiment, the cap 2009 can hold the memory device or can be a separate memory device. The cap 2009 can function similar to the locket described above to transfer and share links and digital assets by giving the cap to another individual with a pen, which can then obtain the links and digital assets from the pen cap 2009 and return the pen cap 2009 to the owner.

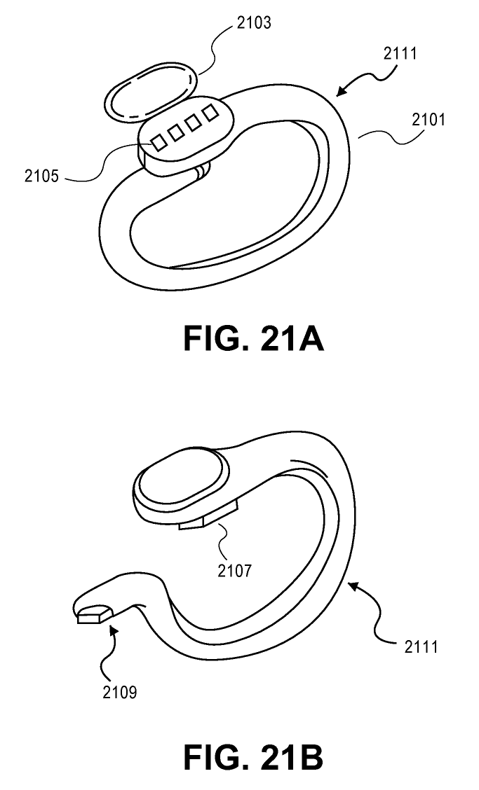

FIGS. 21A and 21B are diagrams of one embodiment of the memory device in the form of a bracelet. FIG. 21A is an illustration of the bracelet 2101 with an open clasp or ornament 2103. The bracelet 2101 can have any size, shape or number of ornaments 2103. The bracelet 201 includes a clasp or ornament 2103, a wristband 2111 and input mechanism 2105. The ornament 2103 and wristband 2111 house the components of the memory device. The bracelet 2101 can provide any of the functions of the memory device. The input mechanism 2105 can be used to input data and select data for output.

FIG. 21B is a diagram of one embodiment of the bracelet where the wristband 2111 is decoupled from the ornament 2103 or clasp to reveal a first connector 2109 and second connector 2107. Each connector 2107, 2109 can be used to connect the bracelet 2101 to another electronic device to share and transfer links and digital assets. The connectors 2107, 2109 can also be utilized to connect the bracelet 2101 with other bracelets or jewelry to form new jewelry or accessory items.

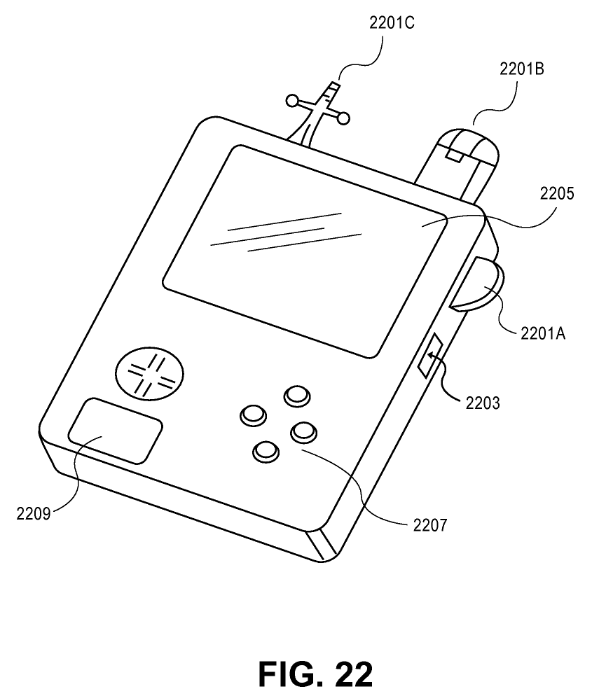

FIG. 22 is a diagram of one embodiment of the memory device in the form of a handheld game device. The handheld game device can provide a single game or may play any number of games that are on removable media. The games may be stored within memory devices (e.g. within the handheld game device) as described herein or may be accessed from other types of media including cartridges, compact discs, mini-discs or similar media. The handheld gaming device may provide an extension of an on-line, network, console or personal computer based game. The links and digital assets can be shared amongst these devices. For example, game items can be transferred between platforms and scores and achievements can be uploaded, transferred or combined across platforms.

The handheld gaming device can include multiple communication ports 2203, input mechanisms 2207, a display device 2205, a sensor 2209 and similar components. Any number of communication ports 2203 can be provided to connect the handheld gaming device to any number of other memory devices 2201A-C. In the illustrated example, memory devices 2201A-C are attached to the handheld gaming device. The form and shape of the memory devices attached to the handheld gaming device represent the digital assets and links that are stored within the memory devices. For example, the handheld device may provide a pirate themed game, where a sword shaped memory device 2201C holds virtual weapons and a treasure chest shaped memory device 2201B stores collected virtual treasure. A separate memory device 2201A may store character data, saved games and similar information.

The display device 2205 provides a visual interface for playing a game. The display device 2205 can also serve as an input mechanism where the display device 2205 is touch sensitive, pressure sensitive or similarly collects input data. Other input mechanisms 2207 can provide the user with game controls in the form of a cross-pad, analog/digital sticks, buttons or similar input mechanisms. In one embodiment, the handheld game device includes a sensor 2209. The sensor 2209 receives non-digital input that can provide new links or digital assets for use in the game or that unlock functionality or gameplay features such as additional levels or character attributes.

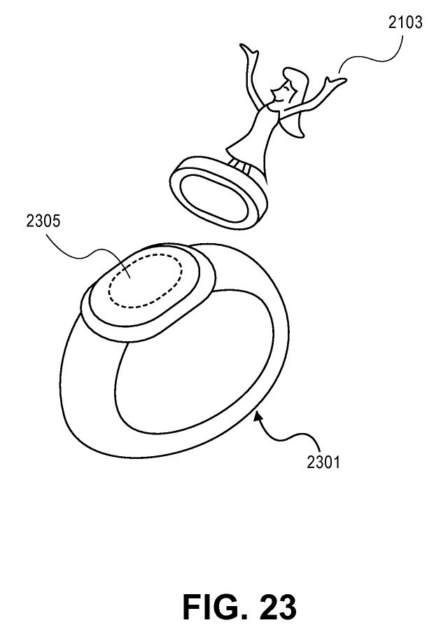

FIG. 23 is a diagram of one embodiment of the memory device in the form of bracelet and a non-digital modifier figurine. The diagram illustrates a bracelet 2301 housing a memory device with a sensor 2305. The sensor 2305 is used to receive non-digital input from external sources such as a figurine 2303. The figurine 2303 may attach to the bracelet 2301 or output a non-digital signal or force that can be detected without physical attachment of the figurine 2303 to the bracelet 2301. For example, the figurine 2303 may include an electro-magnet or similar electro-magnetic force generating device. The sensor detects the electro-magnetic force output by the electro-magnet and generates an analog signal that is converted to a digital value that is stored as new data or used to modify existing data in the bracelet. Any combination of non-digital output sources and sensors can be used in conjunction with one another. In a further embodiment, the figurine 2303 and bracelet 2301 include multiple combinations of non-digital output sources and sensors for receiving the non-digital signals.

FIG. 24 is a flowchart of one embodiment of a process for transferring data between memory devices. This flowchart is an example process for transferring data, one skilled in the art would understand that the process could be modified consistent with the principles and features of the example embodiment to similarly transfer data between devices. The controller and associated components implement the described process within the memory device.

In one embodiment, the transfer of data is initiated in response to a memory device detecting connectivity on one of its communication ports (block 2401). The connectivity may be confirmed through a handshake protocol or similar protocol for establishing communications. In other embodiments, the process can be initiated after connectivity is established upon a request from the connected device, an input selection from a user of the device or under similar circumstances.

The process then determines the type of connectivity (block 2403). Identifying the type of connectivity can include identifying the connected port, protocol, communicating devices and similar information. For example, the memory device may determine the type of device that a USB connection has been established with. The device may decide what data to provide to the connected device based upon the type of device connected. The device may also authenticate the connected device to ensure that it is an approved device for receiving data from the memory device.

The data that is to be transmitted to the connected device is retrieved from the storage device of the memory device (block 2405). The data to be transmitted may be link or digital asset data. The selection of data may be based on input data or the type of device connected. Once the communication has been approved and appropriate data retrieved from the internal storage device, then the memory device transmits stored data across the open communication path (block 2407). The data may be encrypted prior to transmission dependent on the end recipient and characteristics of the data being transmitted and the transmitting device.

The data may be continuously broadcast or retransmitted across all open communication paths or only on selected communication paths until a successful transfer acknowledgement has been received (block 2409). In one embodiment, the process may time out to preserve power in the memory device. Once the transmission has been completed and acknowledged, then the memory device may determine whether the transmitted data, such as a link or digital asset, was unique or subject to a DRM scheme or had similar restrictions placed upon it (block 2413). If no such restrictions are determined, then the transmission process completes (block 2411)

If however the transferred data was unique or subject to a DRM or had similar content restrictions placed upon it, then the process deletes the corresponding data or takes similar measures to satisfy the requirements of the content restriction requirements (block 2415). Once the content restriction requirements are met, then a confirmation signal is sent to the receiving device to confirm the proper transmission of the digital asset or link. If for any reason the transmission cannot be confirmed then the transmission of the digital asset or link is ‘rolled back’ such that it remains resident on the memory device and any part received by the other device is deleted.

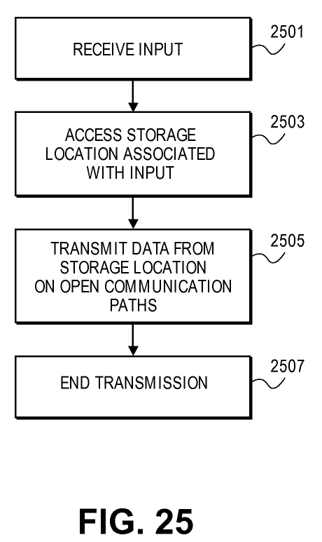

FIG. 25 is a flowchart of one embodiment of a process for output selection. In one embodiment, an input mechanism of a memory device can be utilized to determine an output of the memory device. The process is initiated by receiving an input signal from the input mechanism (block 2501). The input mechanism can generate any type of signal in response to a manipulation of the input mechanism. The signal is interpreted by the controller of the memory device. In one example embodiment, the input signal is interpreted to select data in the form of a link or digital asset stored in the storage device for transmission on an open communication port. One skilled in the art would understand that the principles and features of this process can be adapted for other uses of the input mechanism such as the input of a code, game play interaction and similar functions.

The received input is correlated to a storage location (block 2503). The storage location can be of any size and have any address. The storage location may be in a general storage device utilized by the entire memory device or a specialized storage device tied to the input selection mechanism. The input signal may be correlated with the storage location by a fixed relationship or by any type of encoding or similar scheme. The data at the correlated storage location is then retrieved and the transmission process is initiated to transmit the data over an open communication path (block 2505). The selection process is then complete and awaits the next input selection. The next input selection may be blocked until the previous selection has completed its transfer or the previous transfer can be interrupted to service a new selection.

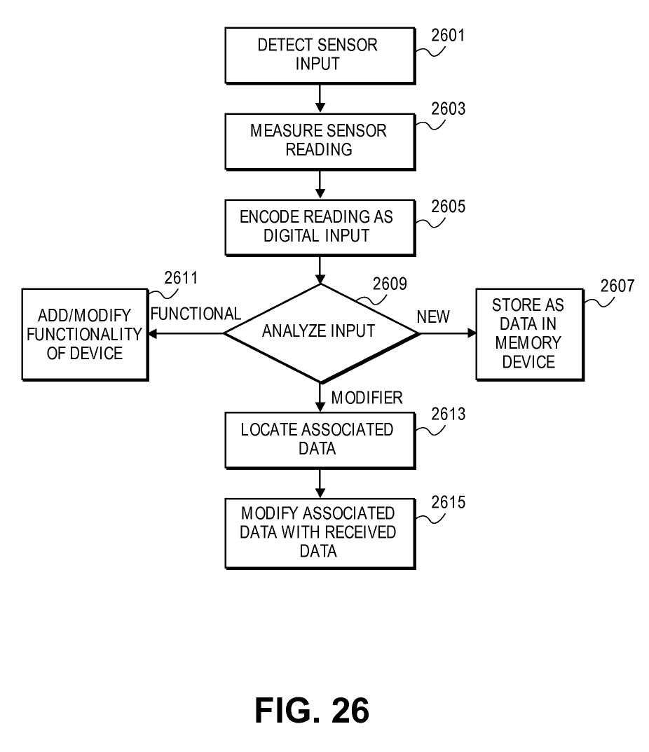

FIG. 26 is a flowchart of one embodiment of a process for handling non-digital input. This process may be initiated in response to the detection of a signal or force by a sensor (block 2601). The type of force or signal that is detected is dependent on the sensors that are available in the memory device. For example, if the sensor is a photodetector then only the change in light levels can be detected by the sensor. The sensor makes a reading or similarly samples the non-digital input source in response to detecting the signal (block 2601). In another embodiment, the sensor continuously takes samples or readings and the process is initiated when a threshold reading or similar trigger is detected.

The non-digital input is then encoded by the sensor, an A/D converter, the controller or similar device (block 2605). The memory device may have a lookup table or similar structure to translate the received signal into a digital value or a similar scheme can be employed to determine a digital value associated with the non-digital input. The non-digital value can also carry its own inherent value. For example, a non-digital input may be a voltage that is translated into an attribute of a digital asset, thus, a 0.001 volt input is translated as a 1000 point damage modifier for a virtual sword. The resulting data can be utilized to modify or create a new link or digital asset. The memory device analyzes the resulting digital value to determine how to process the received data (block 2609).

If the input data is determined to be new data such as a new link or digital asset then it is stored in the storage device to be accessed through the associated on-line environment, network application, or local software application (block 2607). If the input data is determined to be related to a change in memory device functionality, then the change in functionality is implemented (block 2611). The change in functionality may be unlocking a latent function or updating the memory device to include a new function. For example, a change in functionality in a handheld game device may be to unlock a secret level. If the input data is determined to be related to a modification of existing data, then the existing data to be modified is located (block 2613). The associated data may be stored at a known location or a search may be conducted to locate the data. The located data is then modified based on the input data and stored (block 2615). The modification may be to append the new data to existing data or to modify a characteristic or attribute of the existing data or similarly modify the existing data. In one example, an existing link may be modified by adding onto or altering a URL path to create a URL for a new location. In another example, an existing digital asset may be modified to change an attribute. For example, a virtual cape may be modified to have a different or new color.

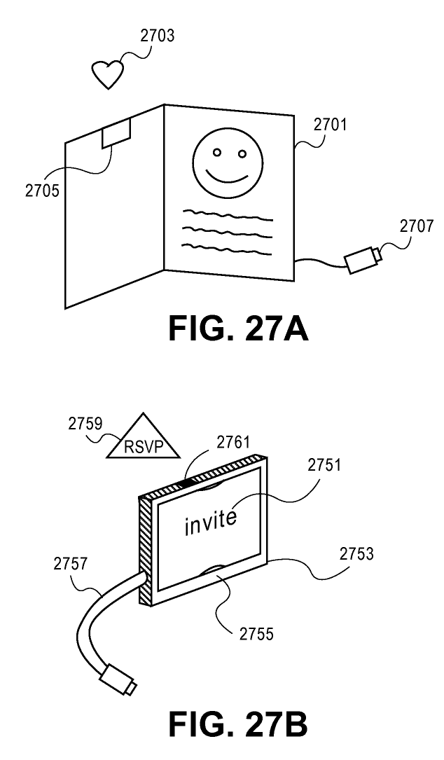

FIGS. 27A and 27B is a diagram of one embodiment of a memory device in the form of a greeting card and card holder. FIG. 27A is a diagram of one embodiment of a greeting card 2701 having an embedded memory device. The greeting card 2701 includes a card body having any type of message or printing thereon, a connector 2707, a sensor 2705 and similar components. The greeting card 2701 may be designed to interact with an external non-digital input source to modify the data within the card, such as heart-shaped envelope, box of candies 2703, or similar item. The greeting card can connect to other memory devices or a personal computer through the connector 2707. Connecting to the personal computer can direct the user to additional content that may be selected by a purchaser of the card and stored in the memory device.

FIG. 27B is a diagram of one embodiment of a card holder. The card holder 2753 may have any dimensions and size suitable for holding any number of cards. The card holder 2753 may be a stationary case or similar type of housing. The card carrying case includes a connector 2757, a holding mechanism 2755, cards 2751, a sensor 2761 and similar components. The connector can be used to load a link or digital asset into the memory device of the card holder 2753. For example, the link may be to a web site for an occasion associated with the cards that has been generated or personalized by the owner of the card case 2753. The cards in the case may each include memory devices as well that are updated when placed in the case and receive the link data. The holding mechanism may be any type of clasp or similar holding mechanism to secure a card or set of cards within or on the card case 2753.

The card carrying case 2753 can include a sensor 2761 to detect non-digital input. The non-digital input may come from a card associated with the carrying case 2753 or similar item. For example, the card carrying case 2753 may be associated with a set of invitations including RSVP cards 2759. The memory device of the carrying case 2753 may receive an input from an RSVP 2759 and record that the RSVP for the associated invitation has been received and update a link or digital asset to record that the invitation has been accepted.

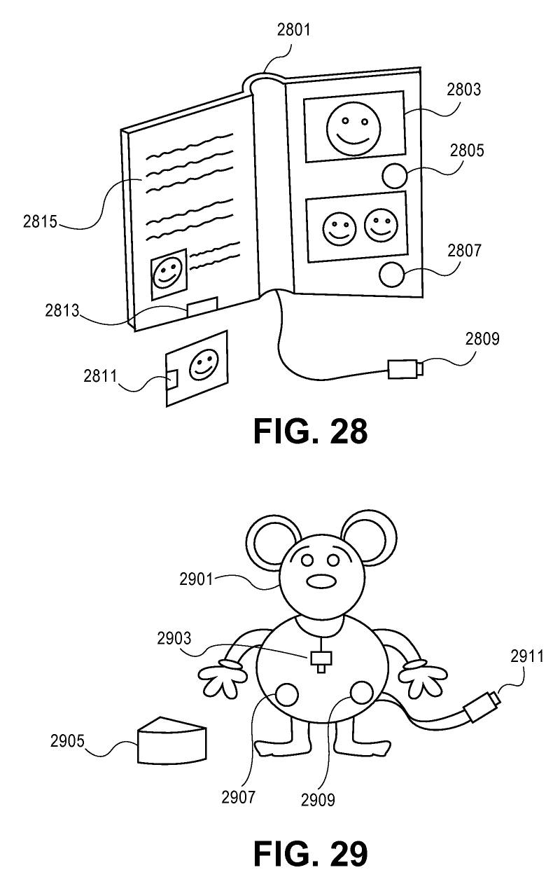

FIG. 28 is a diagram of one embodiment of a memory device in a journal or photo album. The journal or photo album 2801 may include a section for writing, such as a note pade or similar writing area 2815, picture holders 2803, selection buttons 2805, 2807 or similar input mechanisms, a sensor 2813 and a connector 2809. The journal or photo album 2801 may be configured to have any proportion of journal pages and photo pages including embodiments that are exclusively journals and photo albums.

The photo album 2801 may store a link or digital asset associated with each picture or a sub-set of pictures in the album 2801. User selection of a picture using an input mechanism 2805, 2807 causes the memory device 2801 to output the data associated with the selected picture, which may be a link to associated data or a digital asset associated with the picture. In one embodiment, the digital asset is the picture in a digital form. The data can be transferred to a personal computer or another memory device through the connector 2809.

A sensor 2813 can detect non-digital input. The non-digital input source 2811 may be a photo, card or similar item that stores related link or digital asset information. For example, a new photo including a device to output a non-digital signal may be added to the photo album 2801 and the sensor reads the non-digital input and stores data into the picture slot in which the picture is placed.

FIG. 29 is a diagram of one embodiment of a memory device in a plush toy. A plush toy 2901 may take any form or size. In the example, the plush toy 2901 is a mouse. The plush toy can include a connector 2911, input mechanisms 2907, sensor 2909, removable memory device 2903 and internal memory device. The plush toy 2901 may include a memory device that stores links and digital assets associated with a franchise or character that the plush toy 2901 represents. The removable memory device 2903 can store data similar to that stored in the plush toy and may be able to synch with the memory device of the plush toy. The removable memory device 2903 can be any type of accessory associated with the plush toy or character.

The input mechanism 2907 may be on the surface or within the plush toy 2901. The input mechanism 2907 may select an output from the memory device internal to the plush toy 2901. The output connector 2911 in this example is integrated with the tale of the plush toy. An external accessory 2095 (e.g., a piece of cheese associated with the mouse character of the plush toy 2901) can output a non-digital signal that can modify the link or digital assets stored in the embedded memory device. The non-digital signal is sampled and provided to the memory device through the sensor 2909.

The features and processes described herein are also applicable to a wide range of additional products and services. These additional products and service have not been described in detail to maintain the clarity of the features and process. One skilled in the art would understand that these features and processes are also applicable to action figures, toy playsets, apparel, playing cards and/or holders, trading cards and/or holders, gift cards, advertising premiums, greeting cards including everyday and seasonal cards, calendars, note pads, agendas, thank you cards, invitation cards, posters, boxed cards including everyday and seasonal cards, gift card holders, flowers, albums, bookmarks, journals, plush gifts, accessory gifts, occasional or holiday gifts, backpack clips, bags or totes, banks, boxes, candle holders, candy dishes, desk/computer accessories, figurines, jewelry and other accessories, key chains, luggage tags, magnets, mugs, pens or pencils, photo frames, puppets, stationery, vases, tableware, water globes and similar items.

In one embodiment, the memory device and associated data management system are implemented as hardware devices. In another embodiment, these components are implemented in software (e.g., microcode, assembly language or higher level languages). These software implementations are stored on a machine-readable medium. A “machine readable” medium may include any medium that can store or transfer information. Examples of a machine readable medium include a ROM, a floppy diskette, a CD-ROM, a DVD, flash memory, hard drive, an optical disk or similar medium.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
detecting connectivity with a removably coupled memory device by a controller; and
initiating transfer of data by firmware or hardware of the controller from an internal memory device to the removably coupled memory device upon detection of the connectivity, the data including a link to theme based content or a digital asset.

2. The method of claim 1, wherein the link or the digital asset include a unique identifier and pointer.

3. The method of claim 1, further comprising:
deleting the data by the controller after confirmed transfer to the removably coupled memory device.

4. The method of claim 1, wherein the transfer of data is via a universal serial bus or wireless protocol.

5. The method of claim 1, wherein the controller and internal memory device are within any one of a memory stick, handheld gaming device, a toy, a piece of jewelry, a greeting card, journal, a photo album, packaging, a collectible, a personal music player, action figure, playset, apparel, playing card, card holders, trading card, gift card, advertising premium, card, calendar, note pad, posters, gift card holders, flowers, album, bookmark, journal, plush gift, backpack clip, bag, tote, bank, box, candle holder, candy dish, figurine, jewelry, key chain, luggage tag, magnet, mug, pen, pencil, photo frame, puppet, stationery, vase, tableware, water globe.

6. The method of claim 1, wherein the link is a universal resource locator for user created data.

7. The method of claim 1, wherein the digital asset represents a virtual item in an on-line environment, networked environment or a locally installed software program.

8. A method comprising:
detecting a non-digital input from an external source by a personal electronic device including a memory device; and
modifying a link or a digital asset in the memory device in response to the non-digital input.

9. The method of claim 8, further comprising:
altering functionality of the personal electronic device in response to the non-digital input.

10. The method of claim 8, wherein the non-digital input is any one of an electro-magnetic force, a light source, a mechanical force or a kinetic force.

11. The method of claim 8, further comprising:
storing an indicator of the non-digital input in the memory device; and
unlocking functionality or modifying data in response to the indicator in the memory device and a condition of the personal electronic device.

12. The method of claim 8, wherein the personal electronic device is any one of a memory stick, handheld gaming device, a toy, a piece of jewelry, a greeting card, journal, a photo album, packaging, a collectible, a personal music player, action figure, playset, apparel, playing card, card holders, trading card, gift card, advertising premium, card, calendar, note pad, posters, gift card holders, flowers, album, bookmark, journal, plush gift, backpack clip, bag, tote, bank, box, candle holder, candy dish, figurine, jewelry, key chain, luggage tag, magnet, mug, pen, pencil, photo frame, puppet, stationery, vase, tableware, water globe.

13. The method of claim 8, wherein modifying the link comprises:
appending data to a universal resource locator.

14. The method of claim 8, wherein modifying the digital asset comprises:
altering a characteristic of a virtual item that the digital asset represents.

15. An apparatus comprising:
a housing having a portable form factor;
a persistent storage device within the housing to store user data;
a first physical communication connector coupled to the storage device to provide communication with a first electronic device;
a second physical communication connector coupled to the storage device to provide communication with a second electronic device; and
a controller coupled to the persistent storage device and within the housing, the controller to manage data transfer between the persistent storage device and the first physical communication connector or second physical communication connector.

16. The apparatus of claim 15, further comprising:
an input mechanism coupled to the housing, the input selection mechanism to select one of a plurality of stored data items within the persistent storage device to any one of the first physical communication connection or second physical communication connector.

17. The apparatus of claim 15, wherein the housing forms any one of a memory stick, handheld gaming device, a toy, a piece of jewelry, a greeting card, journal, a photo album, packaging, a collectible, a personal music player, action figure, playset, apparel, playing card, card holders, trading card, gift card, advertising premium, card, calendar, note pad, posters, gift card holders, flowers, album, bookmark, journal, plush gift, backpack clip, bag, tote, bank, box, candle holder, candy dish, figurine, jewelry, key chain, luggage tag, magnet, mug, pen, pencil, photo frame, puppet, stationery, vase, tableware, water globe.

18. The apparatus of claim 15, wherein the first physical communication connector is a male connector and the second physical communication connector is a female connector.

19. The apparatus of claim 15, further comprising:
a third physical communication connector to receive a non-digital input.

20. The apparatus of claim 15, further comprising:
an encryption device to encrypt data to be transmitted from the persistent storage device to an external device through the first physical communication connector or the second physical communication connector.

21. The apparatus of claim 15, further comprising:
a sensor to receive a non-digital input.

22. The apparatus of claim 21, wherein the sensor is any one of a resistor, conductive ink, voltmeter, ammeter, ohmmeter, thermometer or photodetector.
